(19) United States
(12) Patent Application Publication
(10) Pub. No.: US 2024/0104632 A1
(43) Pub. Date: Mar. 28, 2024

(54) ITEM ATTRIBUTE DETERMINATION USING A CO-ENGAGEMENT GRAPH

(71) Applicant: Maplebear Inc. (dba Instacart), San Francisco, CA (US)

(72) Inventors: Creagh Briercliffe, Vancover, British Columbia (CA); Chuan Lei, Los Altos, CA (US); Saurav Manchanda, Seattle, WA (US); Min Xie, Santa Clara, CA (US)

(21) Appl. No.: 17/935,916

(22) Filed: Sep. 27, 2022

(51) Int. Cl. G06Q 30/06

(52) U.S. Cl. CPC G06Q 30/0635; G06Q 30/0613; G06Q 30/0627; G06Q 30/0639

(57) ABSTRACT

An online concierge system uses a co-engagement graph to assign attribute values to items for which those attribute values are uncertain. A co-engagement graph is a graph with nodes that represent items and edges that represent co-engagement between items. The online concierge system generates a co-engagement graph for a set of items based on item engagement data and item data for the items. The set of items includes items for which the online concierge system has an attribute value for a target attribute and items for which the online concierge system does not have an attribute value for the target attribute. The online concierge system identifies a node that corresponds to an unknown item and identifies a node connected to that first node that corresponds to a known item. The online concierge system assigns the attribute value for the known item to the unknown item.

### BACKGROUND

An online concierge system is an online system by which users can order items to be provided to them from a retailer. The online concierge system receives item data describing characteristics of items offered by the retailer. The online concierge system uses the item data to select items to display to a user for the user to possibly order. However, the item data received from retailers generally is not formatted for use by the online concierge system. For example, the item data is commonly free text describing the items that are available from the retailer, however the free text is generally written for human use rather than for interpretation by a computing system. Thus, online concierge systems are generally unable to easily determine attribute values for items for which attribute values are missing.

### SUMMARY

In accordance with one or more aspects of the disclosure, an online concierge system uses a co-engagement graph to assign attribute values to items for which those attribute values are uncertain. A co-engagement graph is a graph with nodes that represent items and edges that represent co-engagement between items. A user co-engages with items when the user has engaged with each of the items (e.g., by ordering both items in the same order). The edges between nodes include weight values that represent a measure of the co-engagement between the items represented by the nodes. For example, the weight value for an edge may represent the number of times the corresponding items have been ordered within the same order.

The online concierge system generates a co-engagement graph for a set of items based on item engagement data and item data for the items. The set of items includes items for which the online concierge system has an attribute value for a target attribute (e.g., “known items”) and items for which the online concierge system does not have an attribute value for the target attribute (e.g., “unknown items”). The online concierge system identifies a node that corresponds to an unknown item and identifies a node connected to that first node that corresponds to a known item. The online concierge system assigns the attribute value for the known item to the unknown item. In cases where more than one node for a known item is connected to the node for the unknown item, the online concierge system may use a voting method to determine which attribute value to use for the unknown item. The online concierge system then stores the attribute value in association with the item.

The co-engagement graph allows the online concierge system to determine the attribute values of items without necessarily using a complex, supervised machine-learning model that can be very computationally expensive to operate. Instead, the online concierge system uses the specific co-engagement graph data structure to improve the computational efficiency of the system by simply relying on the attribute values of items with which users have co-engaged. Additionally, the co-engagement graph allows the online concierge system to iteratively determine attribute values for items based on the attribute values of items with which the item is not necessarily directedly connected, thereby improving the scope of items for which the online concierge system can determine attribute values.

### BRIEF DESCRIPTION OF THE DRAWINGS

FIG. 1 illustrates an example system environment for an online concierge system, in accordance with one or more illustrative embodiments.

FIG. 2 illustrates an example system architecture for an online concierge system, in accordance with one or more illustrative embodiments.

FIG. 3 is a flowchart for a method of assigning attribute values to items, in accordance with some embodiments.

FIGS. 4A and 4B illustrate a node for a known item and a node for an unknown item in a co-engagement graph, in accordance with one or more illustrative embodiments.

FIG. 5 illustrates a node for an unknown item that is connected to multiple nodes for known items through edges, in accordance with some embodiments.

FIG. 6A-6C illustrate an attribute value propagating through nodes in a co-engagement graph, in accordance with one or more illustrative embodiments.

### DETAILED DESCRIPTION

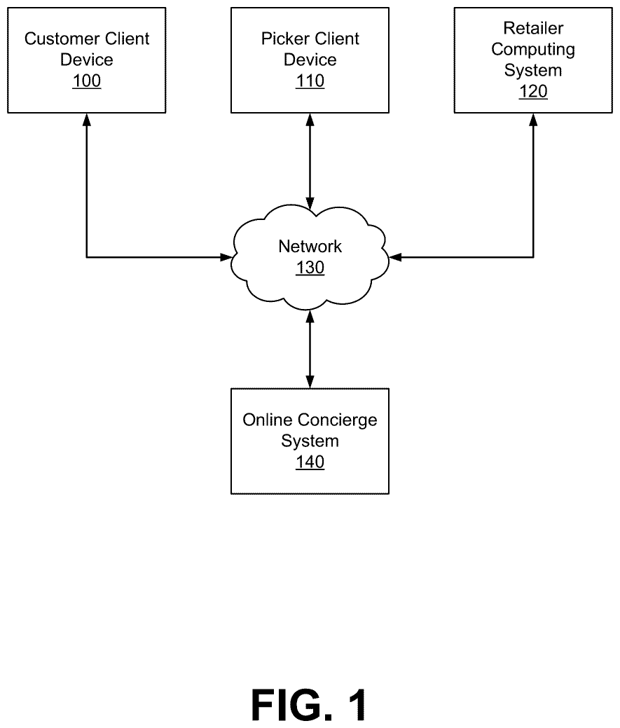

Figure (FIG. 1 illustrates an example system environment for an online concierge system 140, in accordance with some embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item”, as used herein, means a good or product that can be provided to the customer through the online concierge system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the deliver location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer such that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In some embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provide item data indicating which items are available a retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from customer client devices 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provides portions of the payment from the customer to the picker and the retailer.

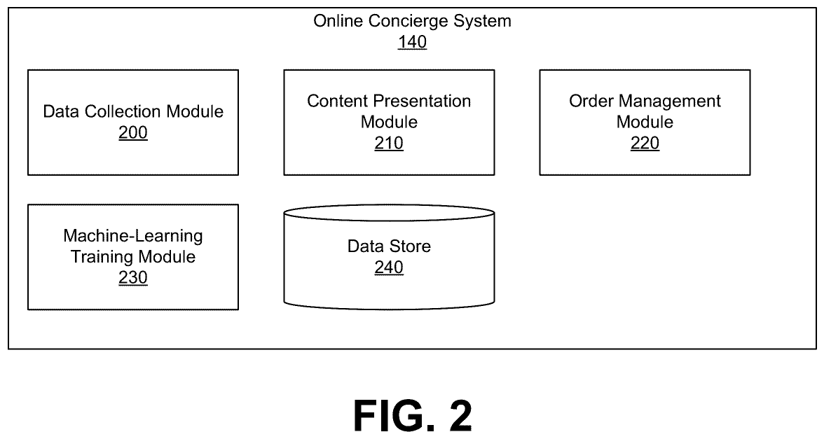

As an example, the online concierge system 140 may allow a customer to order groceries from a grocery store retailer. The customer's order may specify which groceries they want delivered from the grocery store and the quantities of each of the groceries. The customer's client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

Item data for an item may indicate an item category to which the item belongs. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has services orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine-learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine-learning models and may be stored in the data store 240.

In some embodiments, the content presentation module 210 scores items based on a search query received from the customer client device 100. A search query is text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from customer client devices 100 and assigns the orders to pickers for service based on picker data. For example, the order management module 220 assigns an order to a picker based on the picker's location and the location of the retailer location from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine-learning training module 230 trains machine-learning models used by the online concierge system 140. The online concierge system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers.

Each machine-learning model includes a set of parameters. A set of parameters for a machine-learning model are parameters that the machine-learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include customer data, picker data, item data, or order data. In some cases, the training examples also include a label which represents an expected output of the machine-learning model. In these cases, the machine-learning model is trained by comparing its output from input data of a training example to the label for the training example.

The machine-learning training module 230 may apply an iterative process to train a machine-learning model whereby the machine-learning training module 230 trains the machine-learning model on each of the set of training examples. To train a machine-learning model based on a training example, the machine-learning training module 230 applies the machine-learning model to the input data in the training example to generate an output. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

The data store 240 stores data used by the online concierge system 140. For example, the data store 240 stores customer data, item data, order data, and picker data for use by the online concierge system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

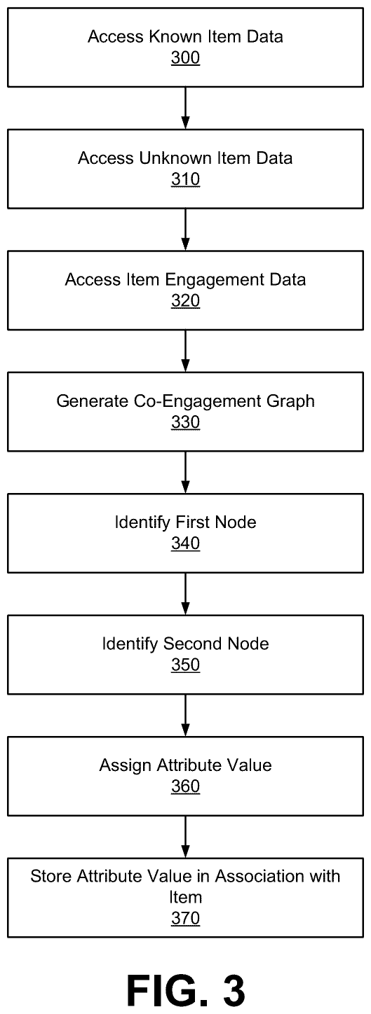

FIG. 3 is a flowchart for a method of assigning attribute values to items, in accordance with some embodiments. Alternative embodiments may include more, fewer, or different steps from those illustrated in FIG. 3, and the steps may be performed in a different order from that illustrated in FIG. 3. These steps may be performed by an online concierge system (e.g., online concierge system 140). Additionally, each of these steps may be performed automatically by the online concierge system without human intervention.

The online concierge system accesses 300 known item data and accesses 310 unknown item data. Item data is data describing characteristics of items offered by the online concierge system. Item data for an item includes attributes of the item, which are qualities, features, or characteristics of an item. Example attributes include the size, color, weight, stock keeping unit (SKU), or serial number for the item. Attributes may also indicate whether the item is organic, whether the item is gluten free, or whether the item is vegan or vegetarian. Items may have attributes that are based on an item category to which the item belongs. For example, bread items may have attributes that indicate whether the bread was baked within the last 24 hours. Each attribute has an attribute value that indicates whether an item has an attribute or what kind of attribute the item has. For example, an attribute value may be a Boolean value (e.g., whether an item is or is not vegan) or may have a numerical value indicative of which attribute an item has (e.g., which of n types of apples a particular apple item is).

Item data may be stored in an item database used by the online concierge system to store item data for items. The item database may have entries for each item and associates each item with attribute values for each of a set of attributes. The online concierge system may access the known item data and the unknown item data from the item database.

Known item data is item data describing characteristics of a set of items for which an attribute value is known for a target attribute, and unknown item data is item data describing characteristics for a set of items for which an attribute value is unknown for the target attribute. In some embodiments, the online concierge system accesses the known item data and the unknown item data by accessing item data for a set of items (e.g., items in an item category) and identifying which of the set of items are known items and which are unknown items.

The term “known item” is used herein to refer to items for which the online concierge system has an attribute value for a target attribute. Similarly, the term “unknown item” is used herein to refer to items for the online concierge system does not have an attribute value for a target attribute. Items may be “known” with respect to one target attribute and may be “unknown” with respect to another target attribute. Thus, while the method illustrated by FIG. 3 may be described with regards to a single target attribute, the method may be used for multiple target attributes with their own corresponding sets of known and unknown items. Accordingly, unknown item data may refer to item data that comprises an attribute value for an attribute other than some target attribute value.

In some embodiments, the online concierge system accesses known item data and unknown item data for items in a target item category. In these embodiments, the target attribute may be an attribute that is specific to the target item category. For example, if the target item category is baby food, the target attribute may be the stage of the baby food (e.g., stage one for infants to stage four for toddlers).

In some embodiments, the online concierge system predicts the attribute value for unknown items by applying a pre-processing step to text data associated with the items. The accessed item data may include text data for each item, which is free text describing an item. For example, an item's text data may be a manufacturer's or retailer's description of the item so that customers can learn more about the item. The text data may describe attributes of items, and the online concierge system may extract attribute values for items based on the text data for unknown items. For example, the online concierge system may apply an attribute prediction model to text data associated with the unknown items to predict the attribute value for the target attribute. The attribute prediction model is a machine-learning model that is trained to predict an attribute value for a target attribute. The attribute prediction model is trained based on training examples generated from known items. Each of these training examples includes text data corresponding to a known item and a label indicating the attribute value for the known item. U.S. patent application Ser. No. 17/407,158, filed Aug. 19, 2021, describes an example method of extracting attributes from unstructured data, and is incorporated herein by reference.

The online concierge system also may predict the attribute value for unknown items by applying an attribute dictionary to the text data for the unknown items. An attribute dictionary is a mapping of regular expressions to attribute values for a target attribute. The online concierge system applies each regular expression in the attribute dictionary to the text data corresponding to an unknown item. If the text data satisfies the regular expression, the online concierge system assigns the unknown item the attribute value corresponding to the regular expression. In some embodiments, if the text data for an unknown item satisfies multiple regular expressions that correspond to different attribute values, the online concierge system does not assign an attribute value to the unknown item.

The online concierge system accesses 320 item engagement data for the set of known items and the set of unknown items. Item engagement data is data that describes characteristics of customer engagement with items on the online concierge system. For example, the item engagement data for an item may describe how often customers purchase the item, which orders include the item, when those orders were placed, how often the item was replaced with another item, or customer accesses to a page describing the item. In some embodiments, the item engagement data includes item data, order data, customer data, or any other data collected by the online concierge system.

The online concierge system generates 330 a co-engagement graph based on the known item data, the unknown item data, and the item engagement data. A co-engagement graph is a graph that indicates co-engagement between items by customers. A customer co-engages with items when the customer has engaged with each of the items. For example, a customer may co-engage with items when they include the items in the same order, order the items in orders placed within a set time period, view pages describing the items within an ordering session, or accept one item as a replacement for another item. The co-engagement graph has nodes that correspond to items from the set of known items and the set of unknown items. Edges connect pairs of nodes, and indicate co-engagement between items corresponding to the nodes. Each edge includes a weight value that indicates a measure of co-engagement between two items. For example, the weight value may be computed based on the number of times the items have been included in the same order, the number of times the items have been ordered by the same customer in separate orders but within a time period, the number of times a customer has viewed a page describing one item and then a page describing the other item, or the number of times a customer has accepted a replacement of one item for the other. In some embodiments, the weight value is simply the number of times the items have been ordered together in any order.

To determine an attribute value for an unknown item, the online concierge system identifies 340 a first node in the co-engagement graph that corresponds to the unknown item. The online concierge system identifies 350 a second node in the co-engagement graph that corresponds to a known item and that is connected to the first node by an edge. The online concierge system assigns 360 the unknown item the same attribute value as the known item from the second node based on the weight value of the edge between the first node and the second node. For example, the online concierge system may compare the weight value to a threshold value, and only assign the attribute value to the unknown item if the weight value exceeds the threshold. The online concierge system stores 370 the attribute value in association with the unknown item (e.g., in an entry in the item database).

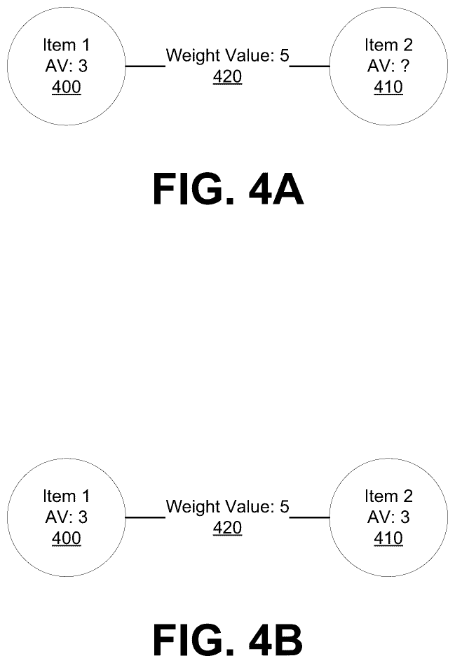

FIGS. 4A and 4B illustrate a node 400 for a known item and a node 410 for an unknown item in a co-engagement graph, in accordance with some embodiments. In FIG. 4A, a known item is associated with an attribute value of 3 for a target attribute. The known item's node 400 is connected to an unknown item's node 410 in the co-engagement graph through an edge 420. As illustrated in FIG. 4B, the online concierge system assigns the unknown item with the attribute value of the known item based on the edge 420 between the known item's node 400 and the unknown item's node 410. The online concierge system may use a threshold for the weight value of the edge 420 before assigning the unknown item the attribute value of the known item. For example, the online concierge system may use a threshold weight value of 4, and since the edge 420 has a weight value of 5, the online concierge system assigns an attribute value of 3 to the unknown item.

In some cases where the first node is connected to more than one other node that corresponds to a known item, the online concierge system assigns an attribute value to the unknown item based on the weight values of the edges connecting the first node to the other nodes. For example, the online concierge system may assign the unknown item the attribute value of the known item corresponding to a node whose edge with the first node has the highest weight value. Alternatively, the online concierge system may use a voting method to determine which attribute value to assign to the unknown item. For example, the online concierge system may identify a set of nodes corresponding to known items that are connected to the first node, and group them based on the attribute values of their corresponding known items. The online concierge system assigns the unknown item an attribute value for the group with the greatest number of known items. In some embodiments, the online concierge system weights the number of nodes in each group based on the weight value of the edges of the nodes in each group. For example, the online concierge system may sum the weight values of the edges of the nodes in each group, and may assign the unknown item the attribute value of the group with the greatest sum of weight values. In some embodiments, the online concierge system uses a label propagating algorithm to assign attribute values to unknown items.

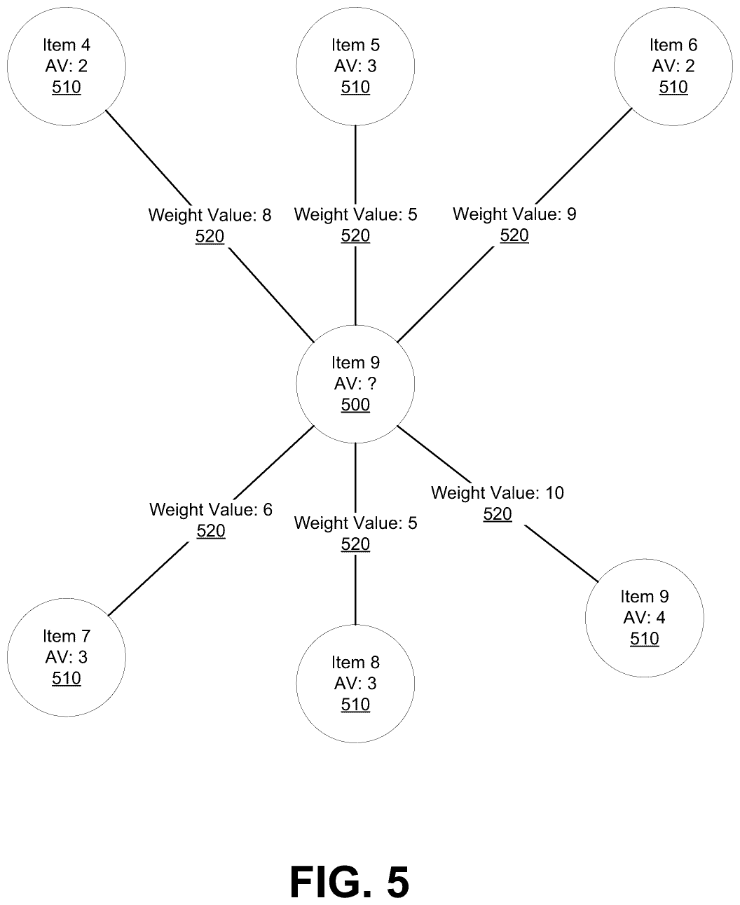

FIG. 5 illustrates a node 500 for an unknown item that is connected to multiple nodes 510 for known items through edges 520, in accordance with some embodiments. The online concierge system assigns one of the attribute values of the known items to the unknown item. To determine which attribute value to assign, the online concierge system may use a voting method. For example, the online concierge system may assign the unknown item an attribute value equal to the attribute value most commonly had by the known items that are connected to the unknown item. In the case illustrated by FIG. 5, the online concierge system would assign the unknown item an attribute value of 3, since three of the six nodes 510 connected to the unknown item's node 500 have attribute values of 3. The online concierge system may also use a sum of the weight values of items of each attribute value to determine which attribute value to assign to the unknown item. In the case illustrated by FIG. 5, the online concierge system would assign the unknown item an attribute value of 2, since items 4 and 6 have edge weights that sum to 17, whereas items 5, 7, and 8 have edge weights that sum to 16 and item 9 has an edge weight of 10. The online concierge system also may simply assign the unknown item an attribute value corresponding to the connected known item with the greatest weight value of the edge 520 between their corresponding nodes. In the case illustrated by FIG. 5, the online concierge system would assign the unknown item an attribute value of 4, since item 9 has the edge 520 with the largest weight value of 10.

The online concierge system may iteratively assign attribute values to unknown items using the steps described above. For example, the online concierge system may identify a node corresponding to another unknown item that is connected to the first node corresponding to the first unknown item after the first unknown item has been assigned an attribute value. The online concierge system assigns an attribute value to the other unknown item based on the assigned attribute value for the first unknown item and the weight value of the edge connecting the first node to the identified node. The online concierge system may continue these iterations until all unknown items that can be assigned an attribute value have been assigned an attribute value.

In some embodiments, the online concierge system may update an attribute value given to a previously unknown item based on attribute values of other previously unknown items. For example, the online concierge system may continually update attribute values, even of known items, until all items have been assigned an attribute value matching the attribute value shared by a maximum number of its neighbors.

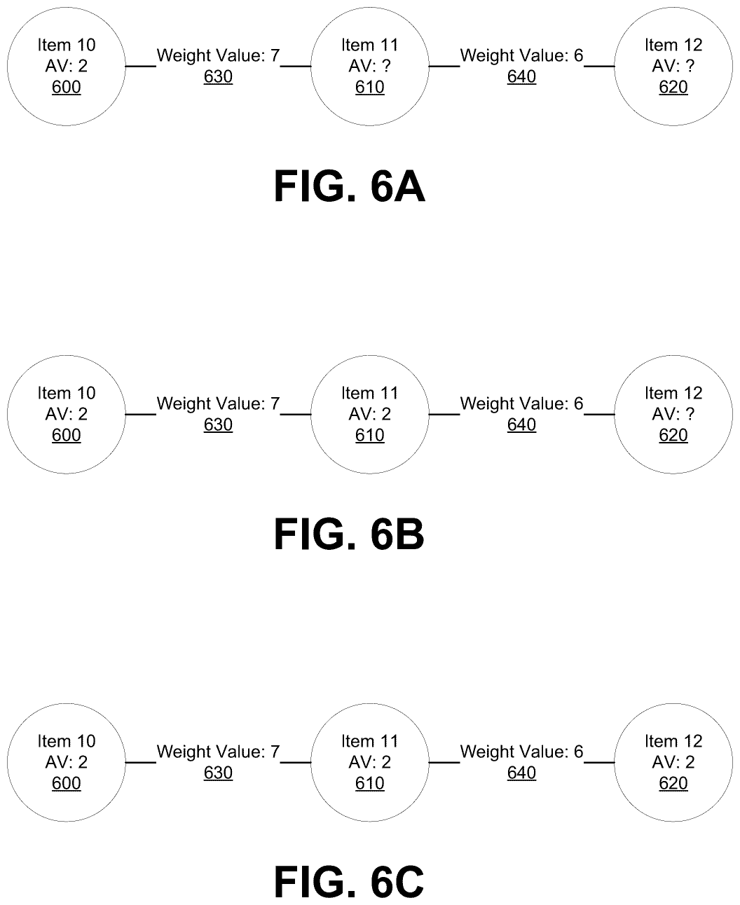

FIG. 6A-6C illustrate an attribute value propagating through nodes in a co-engagement graph, in accordance with some embodiments. In these FIGS., the node 600 for item 10 is connected to the node 610 for item 11 through edge 630, and the node 610 for item 11 is connected to the node 620 for item 12 through edge 640. In FIG. 6A, item 10 has an attribute value of 2, and items 11 and 12 are unknown. In FIG. 6B, item 11 is assigned an attribute value of 2 through a process similar to that described for FIG. 4B. The online concierge system then iterates again, and in FIG. 6C, item 12 is also assigned an attribute value of 2. The online concierge system may repeat this iterative process until all unknown items that can be assigned an attribute value have been assigned an attribute value.

In some cases, a node is not connected to any other node. If that node corresponds to an unknown item, the online concierge system does not assign an attribute value to that unknown item. The online concierge system may use other processes to assign an attribute value to the unknown item. For example, the online concierge system may apply a machine-learning model that is trained to identify attribute values for items based on item data, or may transmit information describing the unknown item to a human operator to determine the attribute value for the unknown item.

### Additional Considerations

The foregoing description of the embodiments has been presented for the purpose of illustration; a person of ordinary skill in the art would recognize that many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
at a computer system comprising a processor and a computer-readable medium:
accessing, from an item database, known item data describing characteristics of a set of known items, wherein known item data for a known item of the set of known items comprises an attribute value for a target attribute of the known item;
accessing, from the item database, unknown item data describing characteristics of a set of unknown items, wherein unknown item data for an unknown item of the set of unknown items comprises an attribute value for an attribute other than the target attribute;
accessing, from the item database, item engagement data comprising data describing characteristics of item engagement by customers of an online concierge system with the set of known items and the set of unknown items;
generating a co-engagement graph based on the known item data, the unknown item data, and the item engagement data, wherein generating co-engagement graph comprises:
generating a node in the co-engagement graph for each item in the set of known items and set of unknown items; and
generating edges between pairs of nodes of the co-engagement graph based on the item engagement data, wherein an edge between a pair of nodes comprises a weight value that indicates a measure of co-engagement between items corresponding to the pair of nodes;
identifying a first node in the co-engagement graph that corresponds to an unknown item from the set of unknown items;
identifying a second node connected to the first node in the co-engagement graph, wherein the second node corresponds to a known item from the set of known items;
assigning, to the unknown item corresponding to the first node, an attribute value corresponding to an attribute value of the known item corresponding to the second node based on a weight value of an edge connecting the first node and the second node; and
storing, in the item database, the attribute value in association with the unknown item corresponding to the first node.

2. The method of claim 1, wherein each item in the set of known items and the set of unknown items are in a target item category.

3. The method of claim 1, wherein accessing the known item data and accessing the unknown item data comprises:
accessing item data stored by the online concierge system, wherein the item data describes characteristics of a set of items, wherein the set of items comprises the set of known items and the set of unknown items; and
identifying the set of known items and the set of unknown items from the set of items based on the item data.

4. The method of claim 3, wherein identifying the set of known items comprises:
identifying a preliminary set of known items and a preliminary set of unknown items based on the item data;
determining attribute values for one or more unknown items of the preliminary set of unknown items based on item data associated with the preliminary set of known items; and
identifying the set of known items based on the preliminary set of known items and the one or more unknown items.

5. The method of claim 4, wherein determining attribute values for one or more unknown items comprises:
applying a machine-learning model to the item data for the one or more unknown items, wherein the item data for the one or more unknown items comprises text data that comprises free text describing the one or more unknown items, and wherein the machine-learning model is trained to determine attribute values for the target attribute based on text data.

6. The method of claim 4, wherein determining attribute values for one or more unknown items comprises:
applying an attribute dictionary to the item data for the one or more unknown items, wherein the item data for the one or more unknown items comprises text data that comprises free text describing the one or more unknown items, and wherein the attribute dictionary comprises a mapping of regular expressions to attribute values.

7. The method of claim 1, wherein generating edges between pairs of nodes of the co-engagement graph comprises:
computing a weight value for an edge based on a number of times items corresponding to a pair of nodes connected by the edge were included in an order together.

8. The method of claim 1, further comprising:
identifying a third node connected to the first node in the co-engagement graph, wherein the third node corresponds to an unknown item from the set of unknown items; and
assigning, to the unknown item corresponding to the third node, an attribute value corresponding to the attribute value of the unknown item corresponding to the third node based on a weight value of an edge connecting the first node and the third node.

9. The method of claim 1, wherein assigning the attribute value to the unknown item corresponding to the first node comprises:
comparing the weight value of the edge between the first node and the second node to a threshold value.

10. The method of claim 1, wherein assigning the attribute value to the unknown item corresponding to the first node comprises:
identifying a set of nodes connected to the first node in the co-engagement graph, wherein the set of nodes includes the second node; and
identifying the attribute value as a most common attribute value among items corresponding to nodes in the set of nodes.

11. A non-transitory computer-readable medium storing instructions that, when executed by a processor, cause the processor to:
access, from an item database, known item data describing characteristics of a set of known items, wherein known item data for a known item of the set of known items comprises an attribute value for a target attribute of the known item;
access, from the item database, unknown item data describing characteristics of a set of unknown items, wherein unknown item data for an unknown item of the set of unknown items comprises an attribute value for an attribute other than the target attribute;
access, from the item database, item engagement data comprising data describing characteristics of item engagement by customers of an online concierge system with the set of known items and the set of unknown items;
generate a co-engagement graph based on the known item data, the unknown item data, and the item engagement data, wherein generating co-engagement graph comprises:
generating a node in the co-engagement graph for each item in the set of known items and set of unknown items; and
generating edges between pairs of nodes of the co-engagement graph based on the item engagement data, wherein an edge between a pair of nodes comprises a weight value that indicates a measure of co-engagement between items corresponding to the pair of nodes;
identify a first node in the co-engagement graph that corresponds to an unknown item from the set of unknown items;
identify a second node connected to the first node in the co-engagement graph, wherein the second node corresponds to a known item from the set of known items;
assign, to the unknown item corresponding to the first node, an attribute value corresponding to an attribute value of the known item corresponding to the second node based on a weight value of an edge connecting the first node and the second node; and
store, in the item database, the attribute value in association with the unknown item corresponding to the first node.

12. The computer-readable medium of claim 11, wherein each item in the set of known items and the set of unknown items are in a target item category.

13. The computer-readable medium of claim 11, wherein the instructions for accessing the known item data and accessing the unknown item data comprise instructions that cause the processor to:
access item data stored by the online concierge system, wherein the item data describes characteristics of a set of items, wherein the set of items comprises the set of known items and the set of unknown items; and
identify the set of known items and the set of unknown items from the set of items based on the item data.

14. The computer-readable medium of claim 13, wherein the instructions for identifying the set of known items comprise instructions that cause the processor to:
identify a preliminary set of known items and a preliminary set of unknown items based on the item data;
determine attribute values for one or more unknown items of the preliminary set of unknown items based on item data associated with the preliminary set of known items; and
identify the set of known items based on the preliminary set of known items and the one or more unknown items.

15. The computer-readable medium of claim 14, wherein the instructions for determining attribute values for one or more unknown items comprises instructions that cause the processor to:
apply a machine-learning model to the item data for the one or more unknown items, wherein the item data for the one or more unknown items comprises text data that comprises free text describing the one or more unknown items, and wherein the machine-learning model is trained to determine attribute values for the target attribute based on text data.

16. The computer-readable medium of claim 14, wherein the instructions for determining attribute values for one or more unknown items comprise instructions that cause the processor to:
apply an attribute dictionary to the item data for the one or more unknown items, wherein the item data for the one or more unknown items comprises text data that comprises free text describing the one or more unknown items, and wherein the attribute dictionary comprises a mapping of regular expressions to attribute values.

17. The computer-readable medium of claim 11, wherein the instructions for generating edges between pairs of nodes of the co-engagement graph comprise instructions that cause the processor to:
compute a weight value for an edge based on a number of times items corresponding to a pair of nodes connected by the edge were included in an order together.

18. The computer-readable medium of claim 11, further storing instructions that cause the processor to:
identify a third node connected to the first node in the co-engagement graph, wherein the third node corresponds to an unknown item from the set of unknown items; and
assign, to the unknown item corresponding to the third node, an attribute value corresponding to the attribute value of the unknown item corresponding to the third node based on a weight value of an edge connecting the first node and the third node.

19. The method of claim 1, wherein the instructions for assigning the attribute value to the unknown item corresponding to the first node comprise instructions that cause the processor to:
compare the weight value of the edge between the first node and the second node to a threshold value.

20. A system comprising:
a processor; and
a non-transitory computer-readable medium storing instructions that, when executed by a processor, cause the processor to:
access, from an item database, known item data describing characteristics of a set of known items, wherein known item data for a known item of the set of known items comprises an attribute value for a target attribute of the known item;
access, from the item database, unknown item data describing characteristics of a set of unknown items, wherein unknown item data for an unknown item of the set of unknown items comprises an attribute value for an attribute other than the target attribute;
access, from the item database, item engagement data comprising data describing characteristics of item engagement by customers of an online concierge system with the set of known items and the set of unknown items;
generate a co-engagement graph based on the known item data, the unknown item data, and the item engagement data, wherein generating co-engagement graph comprises:
generating a node in the co-engagement graph for each item in the set of known items and set of unknown items; and
generating edges between pairs of nodes of the co-engagement graph based on the item engagement data, wherein an edge between a pair of nodes comprises a weight value that indicates a measure of co-engagement between items corresponding to the pair of nodes;
identify a first node in the co-engagement graph that corresponds to an unknown item from the set of unknown items;
identify a second node connected to the first node in the co-engagement graph, wherein the second node corresponds to a known item from the set of known items;
assign, to the unknown item corresponding to the first node, an attribute value corresponding to an attribute value of the known item corresponding to the second node based on a weight value of an edge connecting the first node and the second node; and
store, in the item database, the attribute value in association with the unknown item corresponding to the first node.
